(19) United States
(12) Patent Application Publication
(10) Pub. No.: US 2010/0175808 A2
(43) Pub. Date: Jul. 15, 2010

(54) SYSTEM AND METHOD FOR FABRICATING A PROFILE ENDCAP ON A COUNTERTOP

(75) Inventor: Bradley Hazelwood, Converse, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, UNITED STATES, 317-634-3456, 317-637-7561, DocketDept@uspatent.com

(73) Assignee: Hartson-Kennedy Cabinet Top Co., Inc., Marion, IN (US)

(21) Appl. No.: 12/062,671

(22) Filed: Apr. 4, 2008

Related U.S. Application Data
(60) Provisional application No. 60/910,110, filed on Apr. 4, 2007.

(51) Int. Cl. B32B 38/00; B32B 37/00; B26D 5/00

(52) U.S. Cl. 156/71; 83/821

(57) ABSTRACT

A method comprises providing a laminated countertop workpiece with at least one unfinished end and a profile front edge, and providing a profile edge workpiece in the same color and profile design scheme as the laminated countertop workpiece. Additionally, the method includes cutting a corner molding piece from the profile edge workpiece, and attaching the corner molding piece to a front corner area of the laminated countertop workpiece adjacent and at an angle to the profile front edge and the unfinished end. The method further includes attaching at least a portion of the profile edge workpiece to the laminated countertop workpiece along the unfinished end to continue the profile edge about the laminated countertop workpiece.

### CROSS-REFERENCE TO RELATED APPLICATIONS

This application claims the benefit of Application No. 60/910,110, filed Apr. 4, 2007, to the extent the subject matter of this application is found in that provisional application.

### FIELD OF THE INVENTION

The present disclosure relates generally to countertops and more particularly pertains to systems, methods and apparatuses used to apply a complete profile endcap treatment to the unfinished ends of a laminate countertop.

### BACKGROUND OF THE INVENTION

Post-formed countertop workpieces often include finished, profile front edges, but unfinished side ends. In some cases, a matching flat laminate endcap is applied along the unfinished end using an adhesive, such as contact adhesive or activated thermo-set hot melt adhesive. The applied flat endcap can be routed and/or filed to match the size of the post-formed countertop workpiece. However, the flat endcap on the side as compared to the profile edge along the front does not create an aesthetically-pleasing visual impression of the countertop workpiece. Accordingly, it is desirable to continue the profile design of the front edge along the unfinished side end of the countertop. However, present methods directed to extending the profile around the perimeter of the countertop currently involve applying all the perimeter trim profiles to the countertop as loose molding and mitering all the components where they meet, join and/or change direction. This can be quite costly, both in labor time and materials required.

There is a need for systems and methods for fabricating profile endcaps on laminated countertops.

### SUMMARY OF THE INVENTION

In certain embodiments, a method comprises providing a laminated countertop workpiece with at least one unfinished end and a profile front edge, and providing a profile edge workpiece in the same color and profile design scheme as the laminated countertop workpiece. Additionally, the method includes cutting a corner molding piece from the profile edge workpiece and attaching the corner molding piece to a front corner area of the laminated countertop workpiece adjacent and at an angle to the profile front edge and the unfinished end. The method further includes attaching at least a portion of the profile edge workpiece to the laminated countertop workpiece along the unfinished end to continue the profile edge about the laminated countertop workpiece.

In certain embodiments, a method comprises providing a first laminated countertop workpiece with a color design scheme and at least one unfinished end, with the first workpiece having a profile front edge portion. The method also includes providing a profile strip of countertop having a color design scheme and a profile front edge portion, with the color design scheme and the profile front edge portion of the profile strip of countertop being identical to the color design scheme and the profile front edge portion of the first workpiece. Additionally, the method comprises cutting a corner piece off the first workpiece to form a notch where the profile front edge portion meets the unfinished end. The method may further include cutting corner and end molding pieces from the profile strip of countertop, and attaching the corner and end molding pieces to the first workpiece, with the corner molding piece being at least partially positioned in the notch at an angle to create a beveled corner edge and the end molding piece being positioned along the unfinished end.

In certain embodiments, an apparatus comprises a template for guiding a cutting tool in cutting a notch in a laminated countertop workpiece. The template has a top surface, a bottom surface and an adjoining cutting edge, the cutting edge being substantially perpendicular to the top and bottom surfaces. Additionally, the template includes a stop member attached to the bottom surface, the stop member including a first end surface and a contact surface. The contact surface is configured to be positioned against a front profile edge of a countertop workpiece while at least a portion of the bottom surface rests on the top of the countertop workpiece. Further, the stop member has a first corner where the end surface adjoins the contact surface. The cutting edge includes a first segment and an adjoining second segment, the first corner being aligned with a point along the first segment and the second segment extending at an angle from the first segment in a direction away from the stop member. In some embodiments, the angle between the contact surface and the first segment is about 67.5 degrees, and the angle between the first segment and the second segment is about 112.5 degrees.

### BRIEF DESCRIPTION OF THE DRAWINGS

FIG. 1 is a perspective view of a portion of a finished countertop workpiece according to the present disclosure.

FIG. 2 is a perspective view of a portion of a countertop workpiece having an unfinished side end according to the present disclosure.

FIG. 3 is a bottom view of a template used in accordance with the present disclosure.

FIG. 4 is a perspective view of the template of FIG. 3 positioned on the workpiece of FIG. 2.

FIG. 5 is a top view of a portion of the template of FIG. 3 positioned on a portion of the workpiece of FIG. 2.

FIG. 6 is a perspective view of the workpiece of FIG. 2 having a notch formed therein.

FIG. 7 is a perspective view of a second workpiece according to the present disclosure.

FIG. 8 is a front view of a portion of the template of FIG. 3 positioned adjacent a portion of the workpiece of FIG. 2.

FIG. 9 is a front view of the workpiece of FIG. 2 having another notch formed therein.

FIG. 10 is a top view of another template optionally used in accordance with the present disclosure.

### DETAILED DESCRIPTION OF ILLUSTRATED EMBODIMENTS

For the purposes of promoting an understanding of the principles of the disclosure, reference will now be made to the embodiments illustrated and specific language will be used to describe the same. It will nevertheless be understood that no limitation of the scope of the disclosure is thereby intended, such alterations, modifications, and further applications of the principles of the disclosure being contemplated as would normally occur to one skilled in the art to which the disclosure relates.

The present disclosure is directed to systems and methods for fabricating a profile endcap on a countertop workpiece having a profile front edge with initially unfinished side ends. To form the profile endcap, profile end and corner pieces may be cut from a profile edge workpiece having the same color and design scheme and the same profile shape as the countertop to be finished. In certain embodiments, a notch is cut in the front corner of the countertop to allow for positioning an angled, profile corner piece. The corner piece may be positioned at least partially within the notch, at an angle to the front profile edge of the countertop, with the end piece positioned along the unfinished side end of the countertop. The end and corner pieces are attached to the countertop in an appropriate manner to continue the profile edge perimeter along the horizontal end of the countertop. In certain embodiments, the profile endcap can be continued up the vertical backsplash of the countertop, if present.

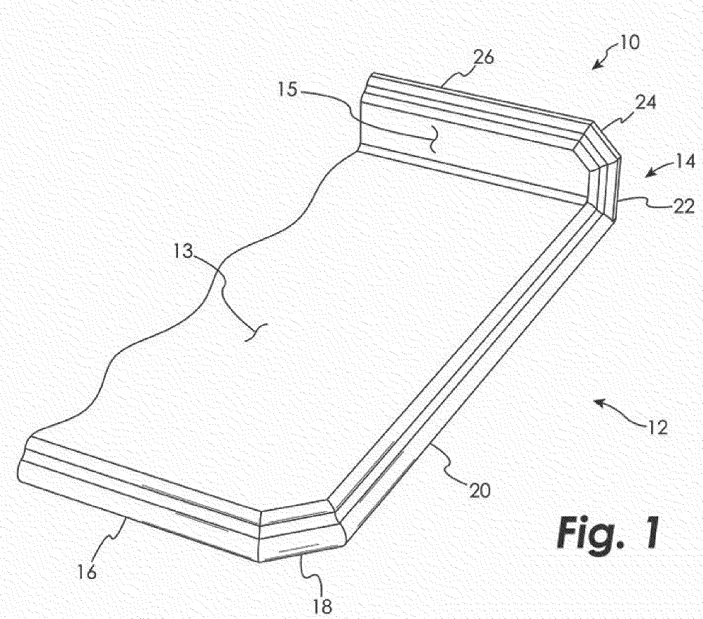

Turning to the illustrations of the present disclosure, FIG. 1 shows a portion of finished countertop 10 with a profile edge extending around the perimeter of the countertop, portions of the profile edge being formed via a method of the present disclosure. Countertop 10 includes a horizontal countertop portion 12 having a top surface 13 and an optional vertical backsplash portion 14 adjoining the countertop portion and having a backsplash surface 15. The complete profile edge extending around countertop 10 includes a front profile edge 16 and a profile endcap, which includes a corner molding or profile piece 18 and a side end molding or profile piece 20, extending around countertop portion 12. In embodiments having a backsplash, the complete profile edge further includes an end molding or profile piece 22, a corner molding or profile piece 24 and a top profile edge 26 extending around backsplash portion 14. For simplicity and clarity, FIG. 1 illustrates only the right side of the finished countertop. In certain embodiments, the left side (not shown) of the finished countertop is a mirror image of the illustrated right side.

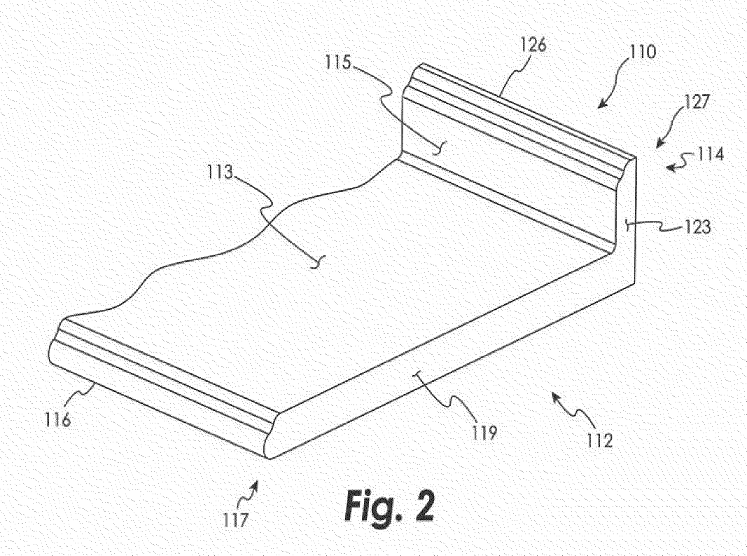

FIG. 2 illustrates a portion of a countertop workpiece 110 which can be finished with a profile endcap to become a finished countertop piece, such as countertop 10 illustrated in FIG. 1. Workpiece 110 includes a horizontal countertop portion 112 having a top surface 113 and a front profile edge 116, and an optional vertical backsplash portion 114 adjoining the countertop portion and having a backsplash surface 115 and a top profile edge 126. As illustrated, workpiece 110 includes an unfinished horizontal end 119 and an unfinished vertical end 123, the unfinished ends being substantially flat and having no profile configuration. The system and method of the present disclosure are directed to providing a profile endcap to the corners and unfinished ends of workpiece 110 (FIG. 2) to convert the workpiece into finished countertop 10 (FIG. 1).

Forming a profile endcap along the unfinished end of countertop portion 112, to create finished countertop portion 12, will be discussed generally with reference to FIGS. 1-7. The method of the present disclosure generally involves the steps of forming a notch in the corner of the countertop to facilitate an angled corner piece, cutting profile pieces 18 and 20 from an extra or supplemental profile front edge, and attaching pieces 18 and 20 to countertop portion 112 at the corner area and along unfinished end 119 to create finished countertop portion 12.

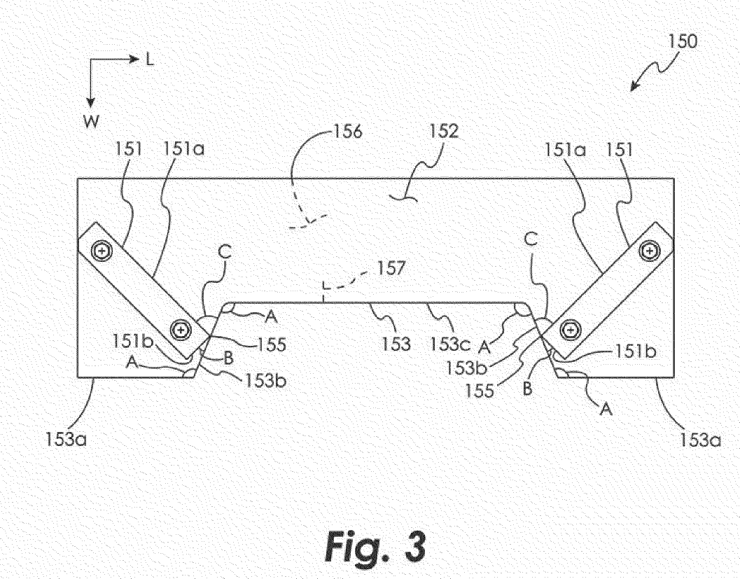

Forming a notch in countertop portion 112 at corner 117 is made more convenient by the use of a unique template 150, best illustrated in FIG. 3, having two mirrored stop members 151, each having a contact surface 151a and an adjoining end surface 151b meeting at corner 155. Template 150 also includes a first surface 152 upon which stop members 151 are attached and an adjoining cutting surface 153 designed to guide a cutting tool along a desired path. In certain embodiments, surfaces 152 and 153 are substantially perpendicular. Template 150 includes a second surface 156 opposite first surface 152 and may also include an alignment mark 157 on surface 156 to assist in aligning the template prior to cutting the notch in the workpiece, as will be discussed in greater detail below.

In the illustrated embodiment, cutting surface 153 includes two mirrored end segments 153a, two mirrored transition segments 153b and a center segment 153c between the transition segments. As illustrated, end segments 153a and center segment 153c are substantially parallel and extend along longitudinal axis L, with transition segments 153b angled between the end segments and the center segment. In certain embodiments, the angle A between end segments 153a and transition segments 153b and the angle A between center segment 153c and transition segments 153b is around 112.5 degrees. Corners 155 may be aligned with points along transition segments 153b. In the illustrated embodiment, the angle B between end surfaces 151b of stop members 151 and transition segments 153b is around 22.5 degrees, and the angle C between contact surfaces 151a of stop members 151 and transition segments 153b is around 67.5 degrees. It should be appreciated that template 150 can be configured otherwise, and the angles between the surfaces varied, to create different angled notches at corner 117 as desired. While the illustrated template 150 includes stop members and cutting segments mirrored from each other about a center line of the template, it should also be appreciated that the template used in accordance with the present method can include a single stop element adjacent a single set of cutting segments. To that end, in certain embodiments the template used in accordance with the present can be the illustrated template 150 cut in half.

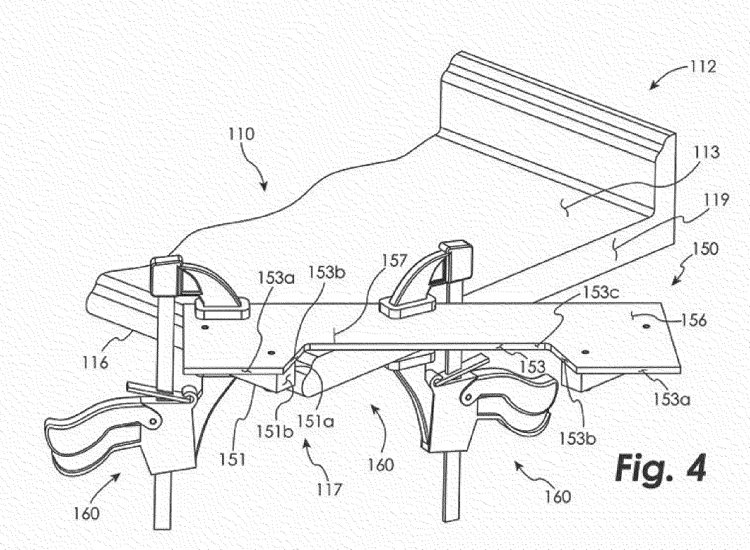

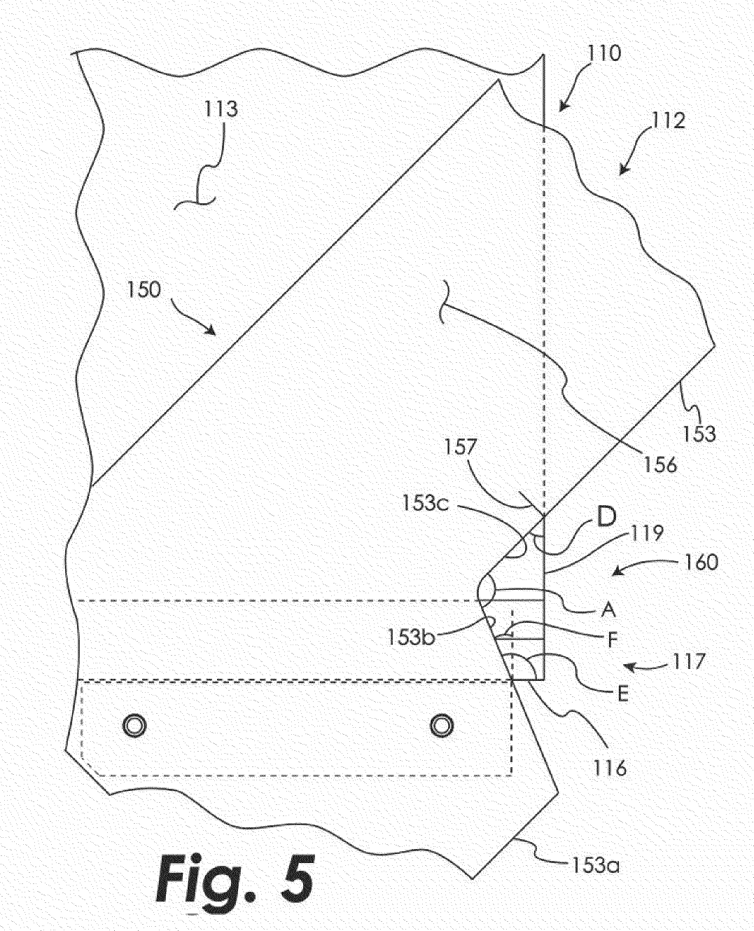

As best illustrated in FIGS. 4-5, template 150 is placed on the laminate side or top surface 113 of countertop portion 112 of workpiece 110. In certain embodiments, template 150 may be clamped to countertop portion 112 via clamps 150. However, it should be appreciated that template 150 can be selectively secured to countertop portion 112 in various other appropriate manners as would occur to one skilled in the art. In alternative embodiments, template 150 rests on top surface 113 and can be temporarily held in position by the user. As illustrated, template 150 is positioned such that contact surface 151a of a stop member 151 abuts front profile edge 116, with alignment mark 157 aligned with unfinished end 119.

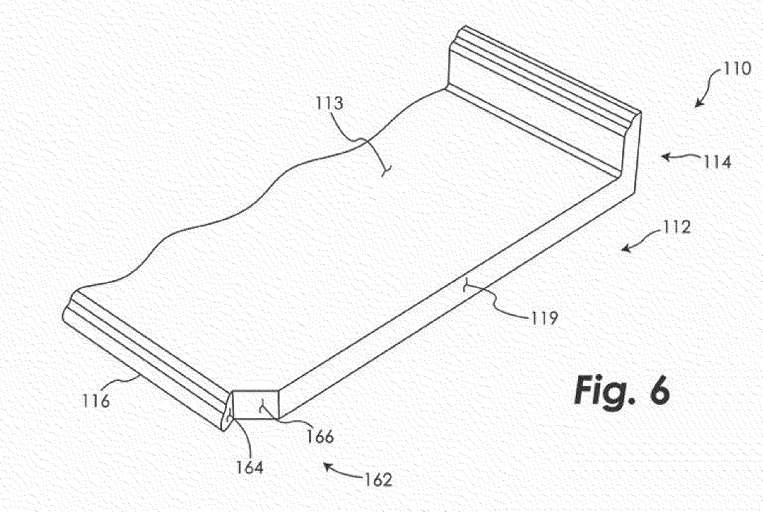

Upon the proper alignment of template 150, a cutting tool such as a router as an example can be used to cut along a portion of transition segment 153b, creating cut surface 164, and a portion of center segment 153c, creating cut surface 166, to cut out a corner portion 160 of workpiece 110 at corner 117, forming notch 162 (see FIG. 6). In certain embodiments, a user manipulates the cutting tool to cut first along transition segment 153b and then along center segment 153c to ensure that the cutting tool rotates toward the laminate (as opposed to particle board) to prevent the laminate from chipping during the cutting process. After cutting out notch 162 with a cutting tool, optionally a filing tool can be used to prepare a relatively sharp inside corner of notch 162 where surfaces 164 and 166 meet by removing any radius left by the cutting tool.

As shown in FIG. 5, the positioning of template 150 on surface 113 creates certain angular relationships between the template (and notch 162 after it's cut) and ends or edges of workpiece 110. In the illustrated embodiment, angle D between center segment 153c and unfinished end 119 is about 45 degrees, angle E between transition segment 153b and the extreme front edge (or any longitudinal axis) of front profile edge 116 is about 112.5 degrees, and angle F between transition segment 153b and a width axis parallel to unfinished end 119 is about 22.5 degrees. As the cuts are made using template 150 as a cutting guide, the cut surfaces 164 and 166 defining notch 162 (see FIG. 6) provide the same angular relationships as cutting line segments 153b and 153c, respectively. The design of notch 162 allows for the insertion and attachment of corner piece 24 at an angle to front edge 116 and end 119 to create a beveled corner edge for the countertop. It should be appreciated that the notch can be sized and configured differently as would occur to one skilled in the art, with the described angular measurements being illustrative examples only. In alternative embodiments, no notch is required to be formed in the countertop workpiece to facilitate attachment of corner piece 24.

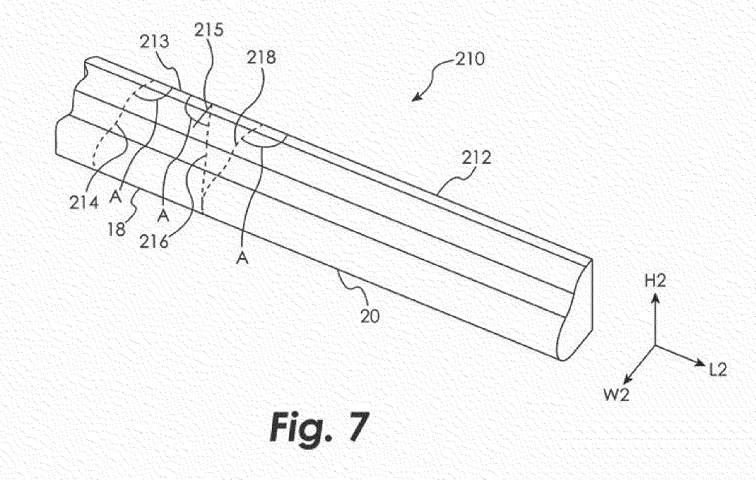

FIG. 7 illustrates a profile edge workpiece 210 which can be used to form corner piece 18 and end piece 20 of finished countertop 10. In some embodiments, workpiece 210 may be a front profile edge of a countertop workpiece, similar to front profile edge 116 of workpiece 110, which has been cut away or otherwise removed or detached from the countertop workpiece. In other embodiments, workpiece 210 may be formed from extra or supplemental countertop material into the configuration as shown in FIG. 7. Workpiece 210 preferably includes the same profile shape, as well as the same color scheme, as workpiece 110 so that the colors and design blend together relatively seamlessly, with any differences being substantially unnoticeable. In certain embodiments, workpiece 210 is at least as long as unfinished end 119, such that profile end piece 20 will cover unfinished end 119, with additional length included for creating corner profile piece 18. In particular example embodiments, workpiece 210 has a length along longitudinal axis L₂ of at least 30 inches and a width along width axis W₂ of at least 1 and 1/16 inches.

To create profile corner piece 18, initially a first angled edge 214 is cut in workpiece 210 which is configured to abut surface 164. Corner piece 18 is designed to fit snugly within notch 162. Accordingly, angled edge 214 is cut at the same angle A of about 112.5 degrees with a back edge 213 of workpiece 210, the same angular relationship between surfaces 164 and 166, with back edge 213 configured to abut surface 166. In certain embodiments, after forming angled edge 214, workpiece 210 may be held up to workpiece 10, with edge 214 contacting surface 164 and edge 213 contacting surface 166. A user can then place a mark 215 on workpiece 210 aligned with unfinished end 119, noting where another angled edge should be cut to create corner piece 18. In the illustrated embodiment, a second angled edge 216 is cut in workpiece 210 at the same angle A of about 112.5 degrees with a back edge 213.

After profile corner piece 18 is cut from workpiece 210, a third angled edge 218 may be cut at the same angle A of about 112.5 degrees with back edge 213 to create profile end piece 20. Edge 218 of end piece 20 is configured to abut edge 216 of corner piece 18. If necessary, another cut (not shown) can be made along workpiece 210 to obtain the proper and desired length of profile end piece 20.

After corner piece 18 and end piece 20 have been cut from workpiece 210, the pieces may be attached to surfaces 164 and 166 defining notch 162 and unfinished end surface 119 by applying an adhesive to the mating surfaces. In certain embodiments, clamping tools may be used to maintain the pieces in the desired positions while the adhesive dries or sets up. However it should be appreciated that the pieces can be attached to workpiece 110 in other appropriate manners as would occur to one skilled in the art. In certain embodiments in which a backsplash portion of the countertop is absent, the finished countertop having a profile edge now formed along the unfinished end is complete. In certain other embodiments having a backsplash portion of the countertop, the profile edge can be continued along the vertical backsplash portion to create the finished countertop.

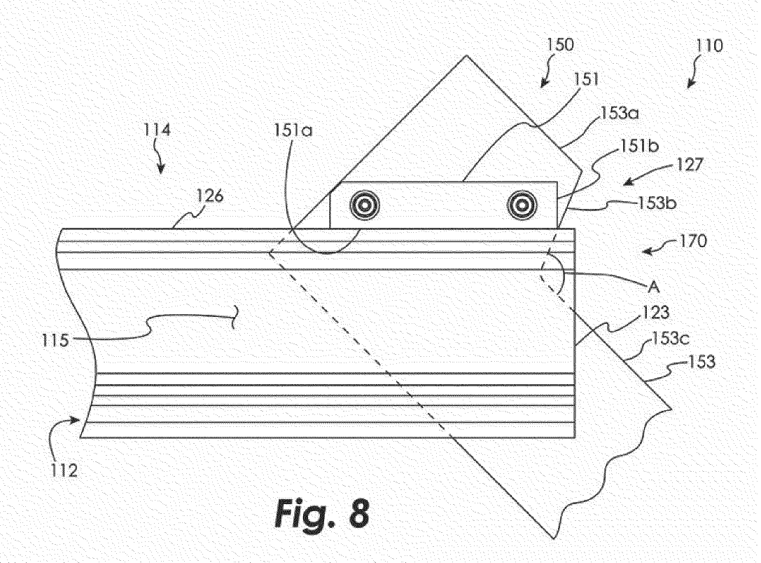

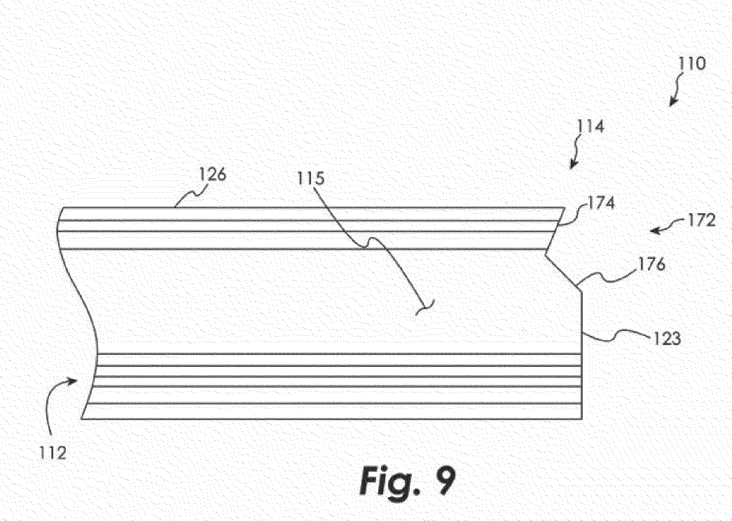

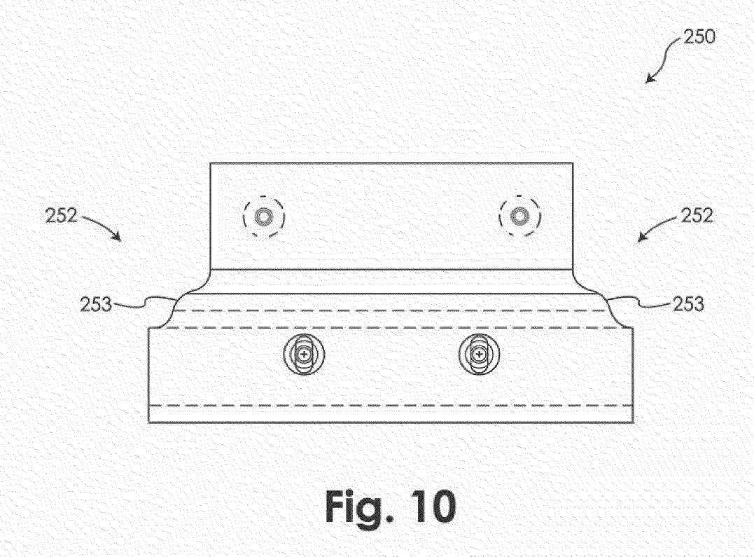

Generally referring to FIGS. 8-10, profile pieces 22 and 24 may be created and attached to backsplash 114 of workpiece 110 in a similar manner as the formation and attachment process for profile pieces 18 and 20 discussed above. In certain embodiments, a notch 172 is created in backsplash portion 114 at corner 127 using template 150 and a cutting tool to cut out portion 170, similar to the process described above in creating notch 162 in countertop portion 112. Template 150 can be positioned adjacent a back side of backsplash portion 114 such that contact surface 151a of stop member 151 abuts the top surface of top profile edge 126, as illustrated in FIG. 8. In certain embodiments, template 150 may be held in the desired position through the use of one or more clamping tools (not shown).

A cutting tool such as a router may be used to cut along portions of segments 153b and 153c of cutting surface 153 to cut out portion 170 from workpiece 110. However, it should be appreciated that notch 172 can be formed via other appropriate methods as would occur to one skilled in the art. In the illustrated embodiment, notch 172 is defined by cut surfaces 174 and 176 and includes the same angular relationships as notch 162. It should be appreciated that the notch can be sized and configured differently as would occur to one skilled in the art, with the described angular measurements being illustrative examples only. In alternative embodiments, no notch is required to be formed in the workpiece to facilitate attachment of corner piece 24.

Profile corner piece 24 and profile end piece 22 can be formed from a profile edge workpiece (not shown). In embodiments where the profile design of top edge 26 is identical to the profile design of front edge 16, the profile edge workpiece used to create pieces 22 and 24 may be identical to profile edge workpiece 210, or workpiece 210 may be of sufficient length to allow for all four profile pieces to be formed therefrom. In other embodiments, the profile edge workpiece used to create pieces 22 and 24 may be of a different shape, design or configuration than workpiece 210 to match the profile design of top edge 26.

In yet other embodiments, the workpiece used to create pieces 22 and 24 may be a strip of laminate countertop having no profile design, thus requiring the matching profile design to be formed in the workpiece (or the corner and end pieces after they are cut from the workpiece). In such cases, a template such as template 250 as an example may be used to guide a cutting tool to cut the profile design into the workpiece. Template 250 includes two profile sections 252 with cutting surfaces 253 defining the profile design. A cutting tool such as a router may be used to cut along surface 253 to create the desired profile design in the workpiece (or in the already cut pieces to be formed into pieces 22 and 24).

Pieces 22 and 24 can be precisely cut from the workpiece using a similar method as described above with reference to the creation of pieces 18 and 20 (see FIG. 7). However, it should be appreciated that the profile pieces 22 and 24 can be formed using different methods as would occur to skilled in the art. Once formed, profile end piece 22 and profile corner piece 24 can be attached to backsplash portion 114 of workpiece 110 to create finished backsplash portion 14. Pieces 22 and 24 can be attached to workpiece 110 using an adhesive material, or in other appropriate manners as would occur to one skilled in the art. The formation and attachment of pieces 22 and 24 to backsplash portion 114 can occur either before or after the formation and attachment of pieces 18 and 20 to countertop portion 112. The attachment of profile pieces 18, 20, 22 and 24 to workpiece 110 provides a continuing profile endcap about the unfinished end of workpiece 110, thereby forming a finished countertop, such as finished countertop 10 illustrated in FIG. 1.

In the illustrated method, a profile endcap is formed along the unfinished right end of a countertop. However, it should be appreciated that the same method can be used to create a profile endcap along the unfinished left side of the countertop. In certain embodiments, when using template 150 to create a notch on the left side of the countertop workpiece (mirroring notch 162 on the right side), the workpiece may be flipped upside down and the template placed on the underside or particle board side of the workpiece. Additionally, it should be appreciated that the illustrated profile design is only one example of a multitude of different profile shapes which could be included on the countertop. In other words, the systems and methods of the present disclosure can be used to form profile edges along countertops having a variety of different profile shapes. Further, regarding templates 150 and 250, in certain embodiments the templates may be formed of a metal material such as aluminum as an example. However, it is contemplated that the templates could be formed of other appropriate materials as would occur to one skilled in the art.

While the disclosure has been illustrated and described in detail in the drawings and foregoing description, the same is to be considered as illustrative and not restrictive in character, it being understood that only the preferred embodiment has been shown and described and that all changes and modifications that come within the spirit of the disclosure are desired to be protected.

What is claimed is:

1. A method, comprising:
providing a laminated countertop workpiece with at least one unfinished end and a profile front edge;
providing a profile edge workpiece in the same color and profile design scheme as said laminated countertop workpiece;
cutting a corner molding piece from said profile edge workpiece;
attaching said corner molding piece to a front corner area of said laminated countertop workpiece adjacent and at an angle to said profile front edge and said unfinished end; and
attaching at least a portion of said profile edge workpiece to said laminated countertop workpiece along said unfinished end to continue the profile edge about said laminated countertop workpiece.

2. The method of claim 1, further comprising creating a notch in said laminated countertop workpiece at said front corner area, wherein said corner molding piece is attached to said laminated countertop workpiece with said corner molding piece being positioned at least partially within said notch at an angle to said profile front edge and said unfinished end of said laminated countertop workpiece to create a beveled corner edge.

3. The method of claim 2, further comprising placing a router template on said laminated countertop workpiece adjacent said front corner area, wherein said creating a notch includes cutting said laminated countertop workpiece with a router along said router template.

4. The method of claim 2, wherein said cutting a corner molding piece includes cutting a first angled edge in said profile edge workpiece, positioning said profile edge workpiece in said notch at an angle to said profile front edge, placing a mark on said profile edge workpiece aligned with said unfinished end, and cutting a second angled edge in said profile edge workpiece at said mark to create said corner molding piece.

5. The method of claim 3, wherein said placing said router template includes clamping said router template to said laminated countertop workpiece via at least one clamping tool.

6. The method of claim 1, further comprising forming an angled edge on said profile edge workpiece configured to mate with an edge of said corner molding piece.

7. The method of claim 1, wherein said attaching said corner molding piece includes applying an adhesive between said corner molding piece and said laminated countertop workpiece and clamping said corner molding piece to said laminated countertop workpiece via a clamping tool.

8. The method of claim 1, wherein said attaching said profile edge workpiece includes applying an adhesive between said profile edge workpiece and said laminated countertop workpiece and clamping said profile edge workpiece to said laminated countertop workpiece via at least one clamping tool.

9. The method of claim 1, further comprising
providing a laminated backsplash workpiece with at least one unfinished backsplash end and a profile top edge;
providing an extra backsplash workpiece in the same color and profile design scheme as said laminated backsplash workpiece;
cutting a backsplash corner molding piece from said extra edge workpiece;
attaching said backsplash corner molding piece to a top corner area of said laminated backsplash workpiece adjacent and at an angle to said profile top edge and said unfinished backsplash end; and
attaching at least a portion of said extra backsplash workpiece to said laminated backsplash workpiece along said unfinished backsplash end to continue the profile edge about said laminated backsplash workpiece.

10. The method of claim 9, further comprising creating a backsplash notch in said laminated backsplash workpiece at said top corner area, wherein said backsplash corner molding piece is attached to said laminated backsplash workpiece with said backsplash corner molding piece being positioned at least partially within said backsplash notch at an angle to said profile top edge of said laminated backsplash workpiece to create a beveled corner edge.

11. The method of claim 9, further comprising creating a profile in said extra backsplash workpiece identical to said profile top edge of said laminated backsplash workpiece.

12. A method, comprising:
providing a first laminated countertop workpiece with a color design scheme and at least one unfinished end, wherein said first workpiece includes a profile front edge portion;
providing a profile strip of countertop having a color design scheme and a profile front edge portion, wherein said color design scheme and said profile front edge portion of said profile strip of countertop are identical to said color design scheme and said profile front edge portion of said first workpiece;
cutting a corner piece off said first workpiece to form a notch where said profile front edge portion meets said unfinished end;
cutting a corner molding piece from said profile strip of countertop;
cutting an end molding piece from said profile strip of countertop;
attaching said corner molding piece to said first workpiece, with said corner molding piece being at least partially positioned in said notch at an angle with said profile front edge portion of said first workpiece to create a beveled corner edge; and
attaching said end molding piece to said first workpiece along said unfinished end adjacent and at an angle to said corner molding piece.

13. The method of claim 12, wherein said cutting said corner molding piece includes selectively positioning a template on said first workpiece and cutting along the template with a cutting tool.

14. The method of claim 12, wherein said providing a profile strip of countertop includes providing a second laminated countertop workpiece and cutting said profile strip of countertop from said second workpiece.

15. The method of claim 12, further comprising:
providing a first laminated backsplash workpiece with at least one unfinished backsplash end and a profile top edge, wherein said laminated backsplash workpiece includes a top corner area where said unfinished backsplash end joins said profile top edge;
providing a second laminated workpiece in the same color design scheme as said first laminated backsplash workpiece;
cutting a backsplash notch into said top corner area of said first laminated backsplash workpiece;
cutting a backsplash corner molding piece from said second laminated backsplash workpiece;
cutting a backsplash end molding piece from said second laminated backsplash workpiece;
attaching said backsplash corner molding piece to said first laminated backsplash workpiece at said top corner area, with said backsplash corner molding piece being positioned at least partially within said backsplash notch; and
attaching said backsplash end molding piece to said first laminated backsplash workpiece along said unfinished backsplash end adjacent and at an angle to said backsplash corner molding piece.

16. The method of claim 15, further comprising creating a profile in said second laminated workpiece identical to said profile top edge of said first laminated backsplash workpiece.

17. An apparatus, comprising:
a template for guiding a cutting tool in cutting a notch in a laminated countertop workpiece, said template having a top surface, a bottom surface and an adjoining cutting edge, said cutting edge being substantially perpendicular to said top and bottom surfaces;
wherein said template includes a stop member attached to said bottom surface, said stop member including a first end surface and a contact surface, said contact surface being configured to be positioned against a front profile edge of a countertop workpiece while at least a portion of said bottom surface rests on the top of the countertop workpiece, said stop member having a first corner where said end surface adjoins said contact surface;
wherein said cutting edge includes a first segment and an adjoining second segment, said first corner being aligned with a point along said first segment and said second segment extending at an angle from said first segment in a direction away from said stop member, wherein the angle between said contact surface and said first segment is about 67.5 degrees, and the angle between said first segment and said second segment is about 112.5 degrees.

18. The apparatus of claim 17, wherein said cutting edge defines a radiused corner profile between first and second segments.

19. The apparatus of claim 17, wherein said template includes a center width and a second stop member attached to said bottom surface mirrored from said first stop member across said center width, wherein said cutting edge includes third and fourth segments mirrored from said first and second segments, respectively, across said center width.

20. The apparatus of claim 17, wherein said template includes an alignment mark on said top surface adjacent said second segment to be aligned with an unfinished end of a laminated countertop workpiece.

21. A method, comprising:
providing a laminated countertop workpiece with at least one unfinished end and a profile front edge;
providing a profile edge workpiece in the same profile edge design scheme as said laminated countertop workpiece;
cutting said profile edge workpiece to create a first angled edge;
cutting said profile front edge to create a second angled edge; and
attaching at least a portion of said profile edge workpiece to said laminated countertop workpiece along said unfinished end to continue the profile edge design scheme about said laminated countertop workpiece.

22. The method of claim 21, further comprising cutting a corner molding piece from said profile edge workpiece; and
attaching said corner molding piece to said first angled edge of said profile edge workpiece and said second angled edge of said profile front edge.

23. The method of claim 22, further comprising attaching at least a portion of said profile edge workpiece to said laminated countertop workpiece along said unfinished end to continue the profile edge design scheme about said laminated countertop workpiece without creating a notch in said laminated countertop workpiece at a front corner area.

24. The method of claim 21, further comprising
providing a laminated backsplash workpiece with at least one unfinished backsplash end and a profile top edge;
providing an extra backsplash edge workpiece in the same profile design scheme as said laminated backsplash workpiece;
cutting said extra backsplash edge workpiece to create a third angled edge;
cutting said profile top edge to create a fourth angled edge; and
attaching at least a portion of said extra backsplash edge workpiece to said laminated backsplash workpiece along said unfinished backsplash end to continue the profile edge design scheme about said laminated backsplash workpiece.

25. The method of claim 24, further comprising cutting a backsplash corner molding piece from said extra backsplash edge workpiece; and
attaching said backsplash corner molding piece to said third angled edge of said extra backsplash edge workpiece and said fourth angled edge of said profile top edge.

26. The method of claim 25, further comprising attaching at least a portion of said profile edge workpiece to said laminated countertop workpiece along said unfinished end to continue the profile edge design scheme about said laminated backsplash workpiece without creating a notch in said laminated backsplash workpiece at a top corner area.

27. An apparatus, comprising:
a template for guiding a cutting tool in cutting a notch in a workpiece selected from the group consisting of: laminated countertop workpiece, profile edge workpiece, laminated backsplash workpiece, and backsplash edge workpiece, said template having a top surface, a bottom surface and an adjoining cutting edge, said cutting edge being substantially perpendicular to said top and bottom surfaces;
wherein said template includes a stop member attached to said bottom surface, said stop member including an end surface and a contact surface, said contact surface being configured to be positioned against a profile edge of a workpiece while at least a portion of said bottom surface rests on the top of the workpiece, said stop member having a corner where said end surface adjoins said contact surface;
wherein said cutting edge includes a first segment and an adjoining second segment, said first corner being aligned with a point along said first segment and said second segment extending at an angle from said first segment in a direction away from said stop member.

28. The apparatus of claim 27, wherein said cutting edge defines a radiused corner profile between said first and second segments.

29. The apparatus of claim 27, wherein the angle between said contact surface and said first segment is about 67.5 degrees, and the angle between said first segment and said second segment is about 112.5 degrees.

30. The apparatus of claim 27, wherein said template includes a center width and a second stop member attached to said bottom surface mirrored from said stop member across said center width, wherein said cutting edge includes third and fourth segments mirrored from said first and second segments, respectively, across said center width.

31. An apparatus, comprising:
a laminate countertop, said laminate countertop having a front profile edge, which front profile edge has a first profile edge design, and a side profile edge, which side profile edge has a second profile edge design;
wherein said first profile edge design and said second profile edge design have the same edge design; and
wherein said first profile edge design and said second profile edge design continue about said laminate countertop.

32. The apparatus of claim 31, further comprising:
a laminate backsplash, said laminate backsplash having a top profile edge, which top profile edge has a third profile edge design, and a side profile edge, which side profile edge has a fourth profile edge design;
wherein said first profile edge design, said second profile edge design, said third profile edge design, and said fourth profile edge design all have the same edge design; and
wherein said third profile edge design and said fourth profile edge design continue about said laminate backsplash.
